(19) United States
(12) Patent Application Publication
(10) Pub. No.: US 2018/0055703 A1
(43) Pub. Date: Mar. 1, 2018

(54) ROCKER RECLINER CHAIR WITH LOCK-OUT MECHANISM FOR SAFE USE OF LIFT-ASSIST FEATURE

(71) Applicants: Luis Miguel Ortiz, Albuquerque, NM (US); Luis M. Ortiz, Albuquerque, NM (US)

(72) Inventors: Luis Miguel Ortiz, Albuquerque, NM (US); Luis M. Ortiz, Albuquerque, NM (US)

(21) Appl. No.: 15/694,527

(22) Filed: Sep. 1, 2017

Related U.S. Application Data
(60) Provisional application No. 62/382,584, filed on Sep. 1, 2016.

(51) Int. Cl. A61G 5/14; A47C 3/03; A47C 7/74; A47C 1/024; A47C 31/00

(52) U.S. Cl. CPC A61G 5/14; A47C 3/03; A47C 31/008; A47C 1/024; A47C 7/74

(57) ABSTRACT

Embodiments are related to a chair with electromechanical reclining features, rocking features, and also lift-assist features to facilitate a person's removal from and entry into the chair. The present embodiments also relate to a rocking, reclining chair that includes a rocking motion lock-out feature to enable safe usage of a lift-assist feature included within the chair to move an occupant upwards towards a standing position.

### PRIORITY OF THE INVENTION

The present embodiments are filed as a continuation application of Provisional Patent Application Ser. No. 62/382,584, by Ortiz et al, entitled “Rocker Recliner Chair with Lock-out Mechanism for Safe use of Lift Feature,” filed on Sep. 1, 2016, which is hereby incorporated by reference in its entirety for its teaching.

### FIELD OF THE INVENTION

The present embodiments are generally related to chairs that include electromechanical reclining and lift assist features. More particularly the present embodiments relate to a recliner chair having reclining and lift-assist features that also includes a rocking feature with a rocking feature lock-out to prevent rocking while the chair is being used in a lift-assist mode. The embodiments also relate to a reclining chair with lift assist and rocking capabilities that further includes heating and cooling features/capabilities integrated within seat and back portions of the chair.

### BACKGROUND

Reclining chairs are a popular style of furnishing for mature users. Reclining chairs often include electromechanical features that enable the back and leg portions of the chair to move into a reclined position wherein the user is practically laying horizontal in the chair. Recliner chairs can also include heating and vibrating massage features throughout its seat and back portions to make the chair occupant even more comfortable. Some reclining chairs are also available with hardware that facilitates a rocking motion of the chair.

Some users of reclining chair furnishings find it difficult to stand up from a sitting position and exit the chair. This is often a problem because of advanced age of the user or because of physical injury or disability. In order to facilitate a user's ability to stand up and exit a chair, some reclining chairs are available with a “lift” or “lift-assist” feature. The lift-assist feature provides electromechanical motion at the base of the chair which causes the back of the seat to tilt upward and forward placing the occupant into, a semi-standing position, wherefrom the occupant can safely and easily exit the reclining chair, as well as safely reenter the chair.

Reclining chair users often like the rocking feature that is available in some reclining chairs, but are unable to safely use reclining chair with a rocking feature because of the difficulty with standing and exiting the chair. Reclining chairs with the lift-assist features do not have a rocking feature because of the instability that rocking motion would cause when the lift-assist feature is being used for a user to exit or enter the chair. For this reason, the users are limited to a reclining chair having a lift-assist feature without a rocking feature, or with a reclining chair having rocking capabilities but no lift-assist feature integrated therein. What is needed is a reclining chair furnishing that provides users ALL of the features that they desire from a reclining chair.

### SUMMARY OF EMBODIMENTS

It is a feature of the embodiments to provide a reclining chair with rocking and lift-assist features that enables a user to safely stand from and exit the reclining chair (or enter it) with the rocking motion disabled.

It is another feature of the embodiments to provide a rocking feature lock-out mechanism that is engaged when a user invokes a “lift-assist” feature on a controller of a reclining chair that incorporates both rocking and lift-assist features.

It is yet another feature of the embodiments to provide a rocking feature locking mechanism that can engage with and lock the rocking mechanism of a reclining chair by mechanical or electromechanical means.

It is yet another feature of the embodiments to provide a reclining chair with heating, vibrating massage, and cooling features integrated with the seat and back section of the reclining chair.

It is another feature of the embodiments to provide a remote control to communicate with the reclining chair and cause it to move into a ready mode prior to a user entering the reclining chair.

It is yet another feature that the ready mode includes at least one of placing the chair into a lift mode so that an occupant can safely enter the reclining chair, preheating the chair using heating elements integrated in sections of the reclining chair, and precooling the chair using cooling elements integrated in sections of the reclining chair.

### BRIEF DESCRIPTION OF DRAWINGS

FIGS. 1A and 1B illustrates a reclining chair with lift and rocking features in accordance with features of the embodiments.

FIG. 2 illustrates a lock-out mechanism for locking the rocking mechanism of a reclining chair with rocking features prior to invoking or engaging a “lift-assist” mode of the reclining chair.

FIG. 3A-B illustrates lock-out features for the locking means.

FIG. 4 illustrates a remote control in communication with a reclining chair.

FIG. 5 illustrates seat back and seat section of a reclining chair with environmental control and vibration features.

### DETAILED DESCRIPTION

Referring to FIGS. 1a and 1b, illustrated are views of a reclining chair 110 with both lift-assist feature 120 and rocking motion feature 130 in accordance with features of the embodiments.

Referring to FIG. 2, illustrated is a schematic diagram of a locking mechanism 135 for locking the rocking motion mechanism 133 of a reclining chair 110 prior to invoking or engaging a “lift-assist” mode of the reclining chair.

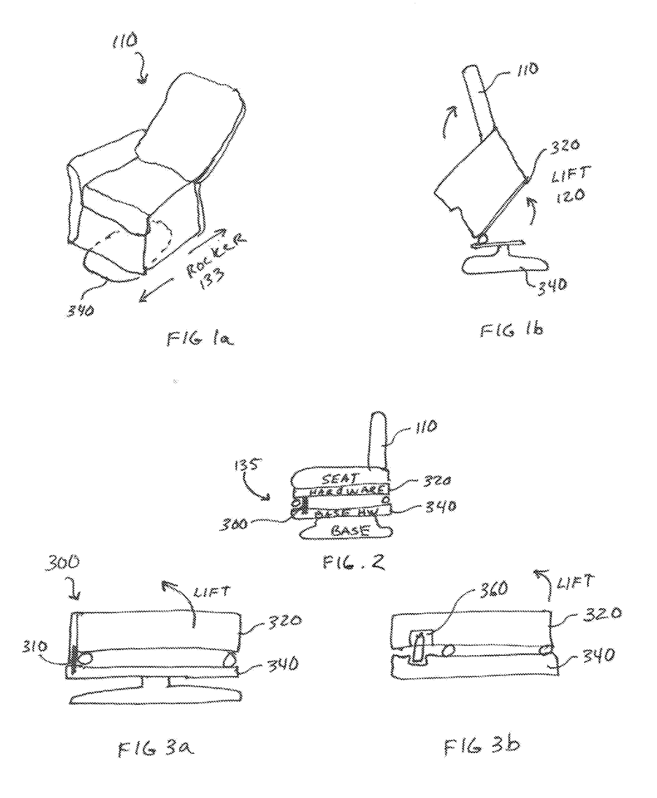

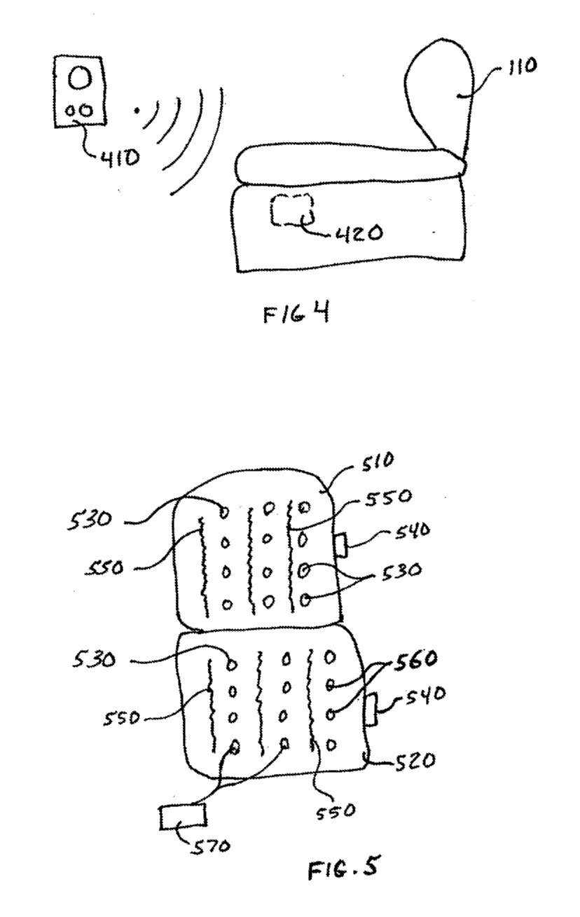

Referring to FIGS. 3A-B, illustrated are lock-out features for the locking mechanism 135. FIG. 3A illustrates a mechanical lock-out feature 300 wherein a bar, pin, or other compatible hardware 310 that can be integrated with the seat section hardware 320 of the reclining chair 110 can engage with the base hardware 340 of the reclining chair 110 to prevent back and forth rocking motion (also known as a rolling motion) when a “lift-assist” feature is invoked. The bar, pin, or other compatible hardware 310 can engage just prior to or when the reclining chair is moving to the “lift” position. FIG. 3B illustrates an automated lock-out feature 360, wherein a electromagnetic, pneumatic, or hydraulic actuated bar, pin, or other hardware 370 that can be integrated with the seat section hardware 320 of the reclining chair 110 and can engages with the base hardware 340 of the reclining chair 110 to prevent rocking motion when a “lift-assist” features is invoked. The bar, pin, or other hardware can engage the seat section hardware 320 and base hardware 340 just prior to or when the reclining chair is moving to the lift position by electromagnetic pneumatic or hydraulic action invoked along with the “lift-assist” feature. It should be appreciated that the hardware 370 providing the lock out feature can also be integrated in the base (rather than the seat) section and would therefore engage with the seat section from the base section (rather than from the seat section to the base section). With location the locking mechanism hardware 320 is integrated with is a mere design or engineering choice and does not take away from the novelty of the embodiment taught herein.

Referring to FIG. 4, illustrated is a remote control 410 that can be used for establishing communication with a controller 420 associated with a reclining chair 110. The remote control can be carried by a user and enable the user to wirelessly cause the recliner chair to go into a ready mode of operation. Ready mode can include preheating, precooling, and/or lifting (tilting forward and upward to facilitate user entry into the chair) the seat portion of the reclining chair prior to entry of the user into the chair 110.

Referring to FIG. 5, illustrated is a scat back section 510 and a seat section 520 of a reclining chair including, environmental control 530 and vibration 540 features therein. The environmental features can include heating elements 550 dispersed throughout the section to warm them, or can include air channels in the form of tubes or slits integrated in cushioning to deliver cooled air from a fan/pump 570 associated with the reclining chair.

What is claimed is:

1. A chair including:
electromechanical reclining feature hardware engageable to cause the seat and seatback of a chair to recline towards a horizontal position for a user;
lift-assist feature hardware engageable to cause the seat and seatback to move into an upward and forward position to facilitate movement of the user into a standing position to facilitate removal of the user from the chair;
rocking motion hardware enabling forward and backward motion of the chair when the chair is being used by the user in seating and reclining positions; and
rocking motion lock-out hardware engageable to lock-out rocking motion hardware and enable safe usage of the lift-assist feature to facilitate safe removal and entry of the user from the chair at a mostly standing position.

2. The chair of claim 1, wherein the rocking motion lock-out hardware further comprises at least one of a bar or pin integrated within seat section hardware of the reclining chair and is engageable with base hardware of the reclining chair to prevent back and forth rocking motion when a lift-assist feature is invoked.

3. The chair of claim 2, wherein the at least one of a bar or pin can engage the base section hardware just prior to or when the reclining chair is moving into a “lift-assist” position.

4. The chair of claim 1, wherein the mechanical lock-out hardware further comprises at least one of a bar or pin integrated within base section hardware of the reclining chair and is engageable with seat section hardware of the reclining chair to prevent back and forth rocking motion when a lift-assist feature is invoked.

5. The chair of claim 4, wherein the at least one of a bar or pin can engage the seat section hardware just prior to or when the reclining chair is moving into a “lift-assist” position.

6. The chair of claim 1, wherein the rocking motion lock-out hardware further comprises at least one of a electromagnetic, pneumatic, or hydraulic actuated bar or pin integrated within seat section hardware of the reclining chair and is engageable with base section hardware of the reclining chair to prevent back and forth rocking motion when a lift-assist feature is invoked.

7. The chair of claim 6, wherein the at least one of a bar or pin can engage the base section hardware by action of the at least one of an electromagnetic, pneumatic, or hydraulic actuation just prior to or when the reclining chair is moving into a “lift-assist” position.

8. The chair of claim 1, wherein the rocking motion lock-out hardware further comprises at least one of a electromagnetic, pneumatic, or hydraulic actuated bar or pin integrated within base section hardware of the reclining chair and is engageable with seat section hardware of the reclining chair to prevent back and forth rocking motion when a lift-assist feature is invoked.

9. The chair of claim 8, wherein the at least one of a bar or pin can engage the seat section hardware by action of the at least one of an electromagnetic, pneumatic, or hydraulic actuation just prior to or when the reclining chair is moving into a “lift-assist” position.

10. The chair of claim 1, further comprising at least one of heating and cooling elements controlled by a controller to either heat or cool the user of the chair.

11. A reclining chair including:
electromechanical reclining feature hardware engageable by mechanical action between seat section hardware and base section hardware to cause the seat and seatback of a chair to recline towards a horizontal position for a user;
lift-assist feature hardware engageable by mechanical action between the seat section hardware and the base section hardware to cause the seat and seatback to move into an upward and forward position to facilitate movement of the user into a standing position to facilitate removal of the user from the chair;
rocking motion hardware enabling forward and backward motion of the chair by mechanical action between the seat section hardware and the base section hardware when the chair is being used by the user in seating and reclining positions; and
rocking motion lock-out hardware engageable to lock-out rocking motion hardware between the seat section hardware and the base section hardware and enable safe usage of the lift-assist feature to facilitate safe removal and entry of the user from the chair at a mostly standing position, wherein the rocking motion lock-out hardware further comprises at least one of a bar or pin integrated within at least one of the chair section hardware or base section hardware of the reclining chair and is engageable between the seat section hardware and base section hardware of the reclining chair to prevent back and forth rocking motion when a lift-assist feature is invoked.

12. The reclining chair of claim 11, wherein the rocking motion lock-out hardware further comprises at least one of a electromagnetic, pneumatic, or hydraulic actuated bar or pin integrated within seat section hardware of the reclining chair and is engageable with base section hardware of the reclining chair to prevent back and forth rocking motion when a lift-assist feature is invoked, wherein the at least one of a bar or pin can engage the base section hardware by action of the at least one of a electromagnetic, pneumatic, or hydraulic actuation just prior to or when the reclining chair is moving into a “lift-assist” position,

13. The reclining chair of claim 11, wherein the rocking motion lock-out hardware further comprises at least one of a electromagnetic, pneumatic, or hydraulic actuated bar or pin integrated within base section hardware of the reclining chair and is engageable with seat section hardware of the reclining chair to prevent back and forth rocking motion when a lift-assist feature is invoked, wherein the at least one of a bar or pin can engage the seat section hardware by action of the at least one of a electromagnetic, pneumatic, or hydraulic actuation just prior to or when the reclining chair is moving into a “lift-assist” position.

14. The chair of claim 11, further comprising at least one of heating and cooling elements controlled by a controller to either heat or cool the user of the chair.

15. The reclining chair of claim 11, further comprising a remote control in wireless communication with a controller integrated with the reclining chair, wherein a user of the remote control can signal the controller to preposition the reclining chair in an upright lift-assist position.

16. The reclining chair of claim 11, further comprising a remote control in wireless communication with a controller integrated with the reclining chair, wherein a user of the remote control can selectively signal the controller to preheat or precool the reclining chair.

17. A reclining chair including:
electromechanical reclining feature hardware engageable by mechanical action between seat section hardware and base section hardware to cause the seat and seatback of a chair to recline towards a horizontal position for a user;
lift-assist feature hardware engageable by mechanical action between the seat section hardware and the base section hardware to cause the seat and seatback to move into an upward and forward position to facilitate movement of the user into a standing position to facility removal of the user from the chair;
rocking motion hardware enabling forward and backward motion of the chair by mechanical action between the seat section hardware and the base section hardware when the chair is being used by the user in seating and reclining positions;
rocking motion lock-out hardware engageable to lock-out rocking motion hardware between the seat section hardware and the base section hardware and enable safe usage of the lift-assist feature to facilitate safe removal and entry of the user from the chair at a mostly standing position, wherein the rocking motion lock-out hardware further comprises at least one of a bar or pin integrated within at least one of the chair section hardware or base section hardware of the reclining chair and is engageable between the seat section hardware and base section hardware of the reclining chair to prevent back and forth rocking motion when a lift-assist feature is invoked; and
at least one of an electromagnetic, pneumatic, or hydraulic actuated bar or pin integrated within the base section hardware or chair section hardware of the reclining chair and the at least one of a pin or bar to prevent back and forth rocking motion when a lift-assist feature is invoked.

18. The chair of claim 17, further comprising at least one of heating and cooling elements controlled by a controller to either heat or cool the user of the chair.

19. The reclining chair of claim 17, further comprising a remote control in wireless communication with a controller integrated with the reclining chair, wherein a user of the remote control can signal the controller to preposition the reclining chair in an upright lift-assist position.

20. The reclining chair of claim 17, further comprising remote control in wireless communication with a controller integrated with the reclining chair, wherein a user of the remote control can selectively signal the controller to preheat or precool the reclining chair.
